(19) United States
(12) Patent Application Publication
(10) Pub. No.: US 2014/0072166 A1
(43) Pub. Date: Mar. 13, 2014

(54) EXTERNAL LOUDSPEAKER AND ELECTRONIC DEVICE WITH THE SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: YE WANG, Shenzhen (CN); YONG-GANG ZHANG, Shenzhen (CN); KUAN-HUNG CHEN, Shindian (TW)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/873,227

(22) Filed: Apr. 30, 2013

(30) Foreign Application Priority Data
Sep. 12, 2012 (CN) 201210334331X

(51) Int. Cl. H04R 1/02

(52) U.S. Cl. CPC H04R 1/02
USPC 381/395

(57) ABSTRACT

An external loudspeaker includes a holding member and a speaker. The holding member includes two clamping portions and a mounting portion located between the two clamping portions, the mounting portion defining a through hole and includes a latching ring. The speaker includes a sealing portion. The sealing portion is deformedly received in the through hole. The sealing portion defines a latching groove, and the latching ring is latched in the latching groove.

### BACKGROUND

1. Technical Field

The disclosure generally relates to loudspeakers and, particularly to an external loudspeaker for electronic devices.

2. Description of Related Art

Multi-function portable electronic devices need to be audio-capable. A portable electronic device may have an internal loudspeaker for implementing the multi-media playing function, and the loudspeaker is commonly received in a sound box of the portable electronic device. The sound box defines a plurality of holes for outputting audio sound waves created by vibration of the loudspeaker. However, the volume of the internal loudspeaker is not high and cannot satisfy the requirement of the user. Thus, an external loudspeaker is often attached to the portable electronic device. However, traditional external loudspeakers cannot be tightly assembled to the portable electronic device, adversely affecting the sound quality of the external loudspeaker. Additionally, a foam is often needed to seal the external loudspeaker. This complicates the assemble process of the external loudspeaker, and the costs are greatly increased.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary external loudspeaker and electronic device with the loudspeaker protection assembly. Moreover, in the drawings, like reference numerals designate corresponding parts throughout the several views. Wherever possible, the same reference numbers are used throughout the drawings to refer to the same or like elements of an embodiment.

FIG. 1 is an exploded view of an exemplary embodiment of an electronic device with an external loudspeaker.

FIG. 2 is an assembled view of the electronic device of FIG. 1.

FIG. 3 is a cross sectional and enlarged view of the electronic device of FIG. 2 along a line of III-III.

FIG. 4 is a curved diagram showing a relationship between acoustic pressure and frequency of the electronic device using the external loudspeaker or not.

### DETAILED DESCRIPTION

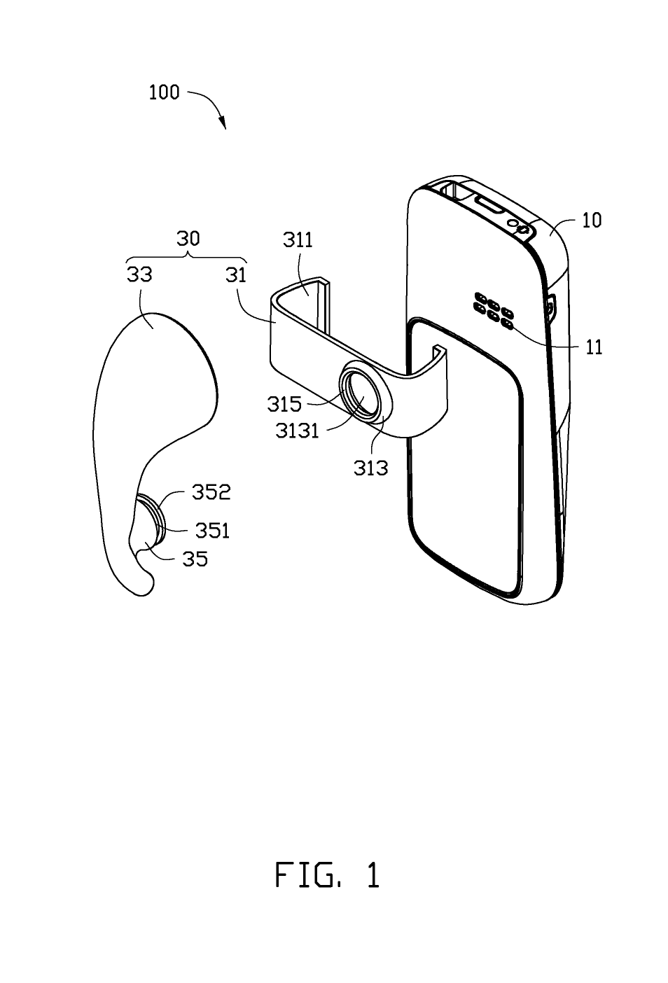

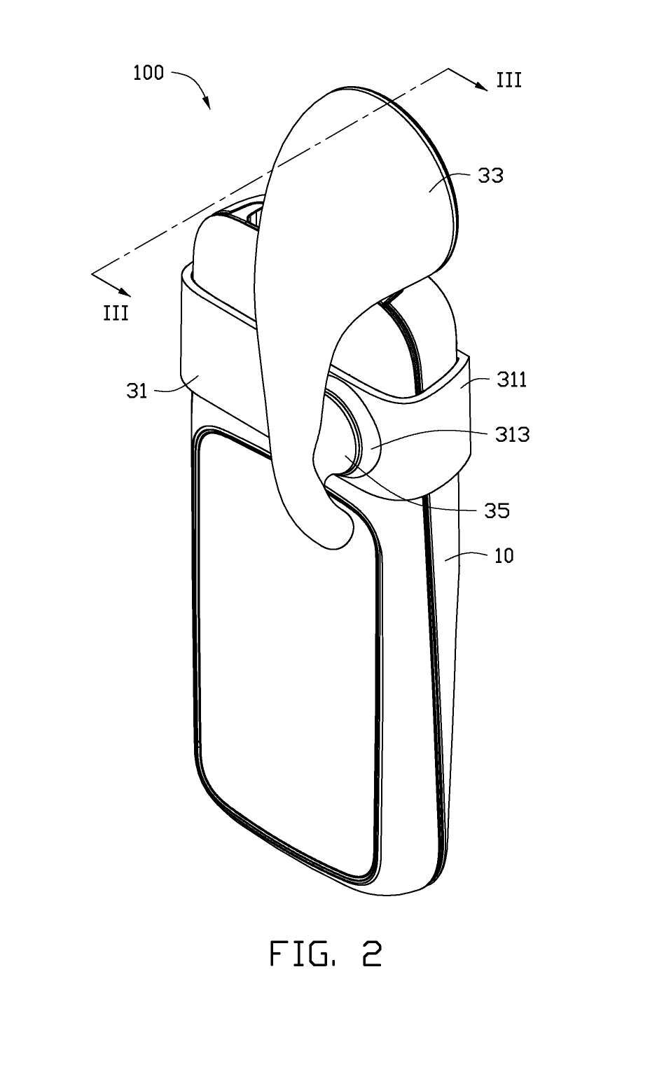

FIGS. 1 and 2 show an exemplary portable electronic device in the form of a mobile phone 100. The mobile phone 100 comprises a housing 10 and an external loudspeaker 30 fixed to the housing 10. The housing 10 defines a plurality of audio output holes 11 that allow the output of sound waves created by an internal loudspeaker of the portable electronic device 100. The external loudspeaker 30 is secured to outside of the portable electronic device 100.

The external loudspeaker 30 comprises a holding member 31 and a speaker 33. The holding member 31 can be formed by injection molding a plastic material. The plastic material can be any of polypropylene (PP), polycarbonate (PC), polyethylene terephthalate (PET), polymethylmethacrylate (PMMA). The holding member 31 includes two L-shaped clamping portions 311 at opposite ends and a mounting portion 313 formed between the L-shaped clamping portions 311. The mounting portion 313 projects from one surface of the holding member 31 and defines a through hole 3131. A latching ring 315 is formed at a distal end of the mounting portion 313.

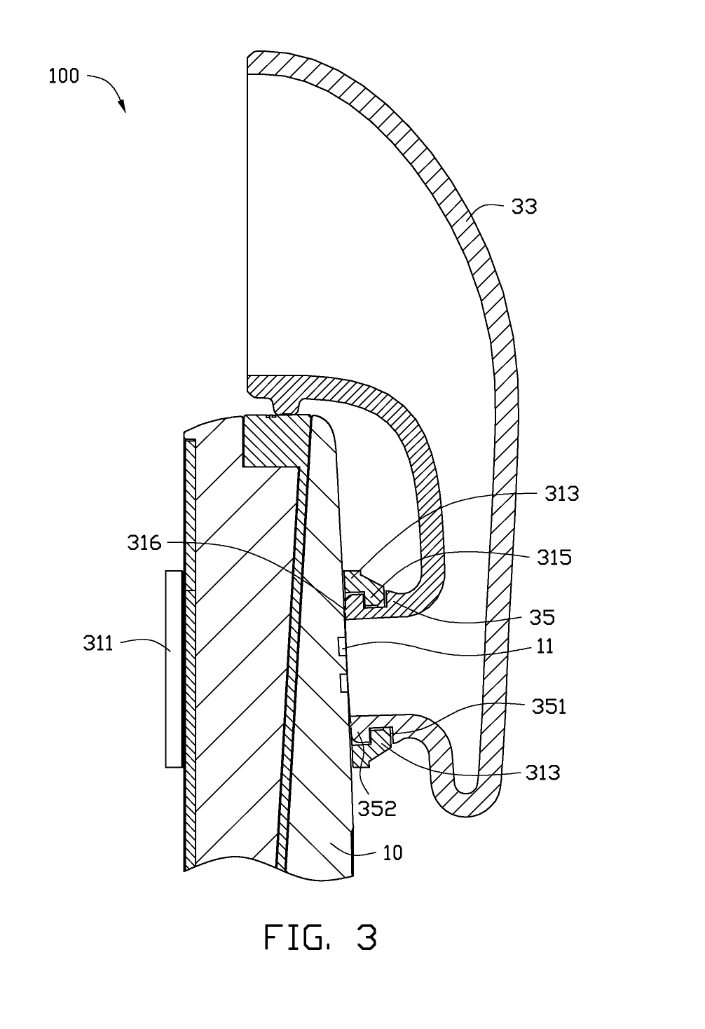

The speaker 33 is used for amplifying the sound waves created by an internal loudspeaker of the portable electronic device 100. The speaker 33 has a sealing portion 35 positioned at one side. The sealing portion 35 is made of elastic material, such as rubber or silica gel. A size of the sealing portion 35 is slightly larger than the through hole 3131 so that the sealing portion 35 may be deformedly received in the through hole 3131. The sealing portion 35 defines a latching groove 351 and a flange 352 is formed at one end of the sealing portion 35 adjacent to the latching groove 351. The sealing portion 35 is configured for being received in the through hole 3131 and the latching ring 315 is latched in the latching groove 351. FIG. 3 shows that a sealing ring 316 is formed on a top surface of the flange 352.

FIGS. 2 and 3 show that in assembly, the sealing portion 35 is aligned with the through hole 3131 and is inserted into the through hole 3131. The sealing portion 35 is elastically deformed to move toward the inside of the mounting portion 313 until the latching ring 315 is latched into the latching groove 351. Thus, the sealing portion 35 is tightly engaged with the holding member 31. After that, the through hole 3131 of the holding member 31 is aligned with the audio output holes 11 and the two clamping portions 311 are clamped on the electronic device 100. The sealing ring 316 of the flange 352 of the sealing portion 35 elastically abuts against the housing 10 and surrounds the audio output holes 11. In this present exemplary embodiment, the holding member 31 is made of hard material and may conveniently be assembled to the electronic device 100. Additionally, the sealing portion 35 is made of soft material and the sealing ring 316 of the speaker 33 is pressed on the electronic device 100 for preventing sound from leaking.

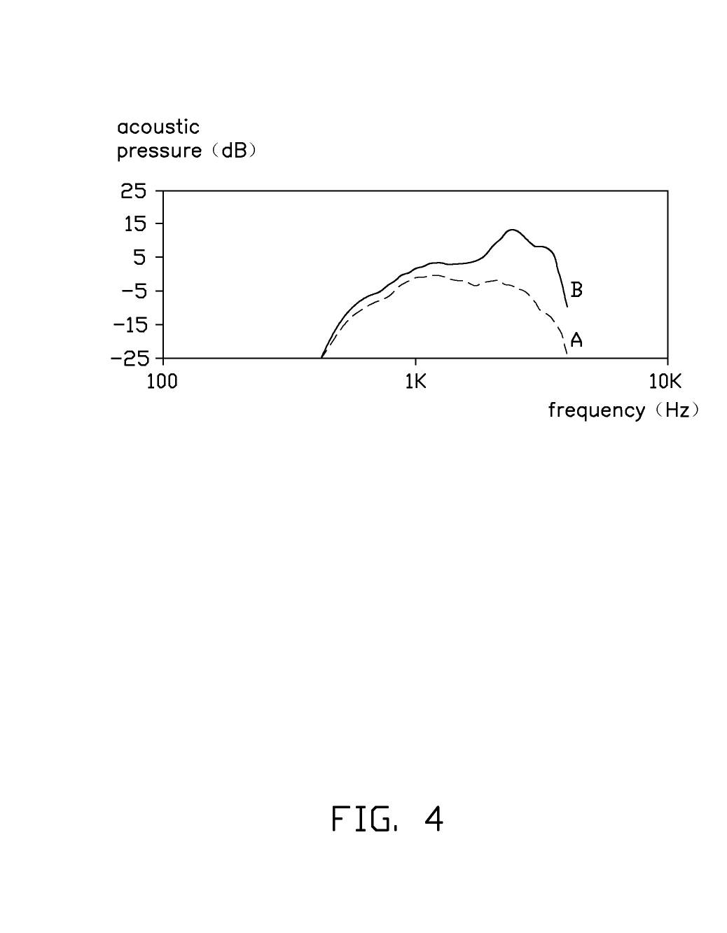

FIG. 4 is a curved diagram showing a relationship between acoustic pressure and frequency of the electronic device using the external loudspeaker or not. Curve A using a broken line represents a relationship between acoustic pressure and frequency of the electronic device without the external loudspeaker 30. Curve B using a solid line represents a relationship between acoustic pressure and frequency of the electronic device using the external loudspeaker 30. Compared to the two curves, the acoustic pressure of the electronic device using the external loudspeaker 30 is higher than that of the electronic device without the external loudspeaker 30 in a high frequency range (e.g. 1 KHZ-7 KHZ). Additionally, from a tested experiment, a loudness of sound of the electronic device 100 without the external loudspeaker 30 is 103.68 phon. However, a loudness of sound of the electronic device 100 using the external loudspeaker 30 is 108.07 phon. Thus, the acoustic pressure and the loudness of sound of the electronic device 100 using the external loudspeaker 30 is improved.

It is to be understood, however, that even through numerous characteristics and advantages of the disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An external loudspeaker comprising:
a holding member comprising two clamping portions and a mounting portion, located between the two clamping portions, and the mounting portion defining a through hole and comprising a latching ring;
a speaker comprising a sealing portion, the sealing portion deformedly received in the through hole, and the sealing portion defining a latching groove and the latching ring latched in the latching groove.

2. The external loudspeaker as claimed in claim 1, wherein the sealing portion is made of elastic material, and the holding member is made of plastic.

3. The external loudspeaker as claimed in claim 2, wherein a size of the sealing portion is slightly larger than the through hole.

4. The external loudspeaker as claimed in claim 3, wherein a flange is located at one end of the sealing portion adjacent to the latching groove, and a sealing ring is located on a top surface of the flange.

5. An electronic device comprising:
a housing;
an external loudspeaker mounted on the housing, comprising:
a holding member comprising two clamping portions and a mounting portion, located between the two clamping portions, and the mounting portion defining a through hole and comprising a latching ring;
a speaker comprising a sealing portion, the sealing portion deformedly received in the through hole, the sealing portion defining a latching groove, and the latching ring latched in the latching groove.

6. The electronic device as claimed in claim 5, wherein a flange is formed at one end of the sealing portion adjacent to the latching groove, and a sealing ring is located on a top surface of the flange for abutting the housing.

7. The electronic device as claimed in claim 5, wherein the sealing portion is made of elastic material, and the holding member is made of plastic.
